(19) United States
(12) Patent Application Publication
(10) Pub. No.: US 2022/0374703 A1
(43) Pub. Date: Nov. 24, 2022

(54) LEVERAGING EXPLANATIONS FOR TRAINING OF AN AI SYSTEM

(71) Applicant: International Business Machines Corporation, Armonk, NY (US)

(72) Inventors: Mattia Rigotti, Basel (CH); Christoph Adrian Miksovic Czasch, Aeugst am Albis (CH); Paolo Scotton, Rueschlikon (CH); Thomas Gschwind, Zürich (CH); Adelmo Cristiano Innocenza Malossi, Schönenberg (CH); Thomas Frick, Winterthur (CH); Filip Michal Janicki, Zürich (CH)

(21) Appl. No.: 17/323,364

(22) Filed: May 18, 2021

(51) Int. Cl. G06N 3/08; G06N 3/04

(52) U.S. Cl. CPC G06N 3/08; G06N 3/04

(57) ABSTRACT

Computer-implemented methods, computer program products, and computer systems for training of an explaining machine-learning model is disclosed. The computer-implemented method may include one or more processors configured for providing an untrained machine-learning model, providing training data for the machine-learning model comprising training input data elements, wherein each of the training input data elements relates to a prediction label representing an expected prediction value as well as to a concept label, wherein the concept label relates to a reason why the expected prediction label is expected given the training input data elements, and simultaneously updating, during a supervised training of the machine-learning model, prediction parameter values as well as concept parameter values, thereby building the explaining machine-learning model.

### BACKGROUND OF THE INVENTION

The present invention relates generally to a method for artificial intelligence, and more specifically, to a computer-implemented method for training an explaining machine-learning (ML) model. The invention relates further to a machine-learning computer system and a computer program product for training an explaining machine learning model.

Artificial Intelligence (AI) systems have become mainstream over the last couple of years and have been introduced as components into enterprise applications. Such computer-implemented methods and machine-learning computer systems are used in a wide variety of different industries and application areas. Often, the underlying ML models are trained in a supervised mode in which a large quantity of annotated data consisting of pairs of input data and desired output data are used. Training proceeds by elaborating each input through the network to obtain an output. The generated output is then compared with the desired output data, a loss function value is generated out of the difference between the generated output and the desired output data and, typically fed back using back propagation to elements of the machine learning model.

However, although the functioning of the so trained ML models is somewhat deterministic, it is clearly not a result of procedural programming. Hence, the output of the machine-learning model in an operational or prediction phase depends very much on the data the model has been trained with. Thus, two artificial intelligence systems with an identical architecture and identical hyper-parameters may generate completely different prediction values depending on the used training data sets. Hence, artificial intelligence systems are often seen as black boxes because the way the AI system comes to a prediction is not transparent. This is one of the reasons there is hesitation to trust and rely on such systems. Additionally, in regulated industries, like the banking or insurance industry, institutions need to be able to provide arguments why certain decisions (e.g., a refusal for a credit line) have been made. If the decisions are based on the predictions of AI systems, this becomes difficult.

Therefore, some attempts have been made to also produce reasons and arguments for specific predictions made by an AI system. However, up to now, such produced grounds for the predictions have had limited success (e.g., due to the fact that they are artificially generated after the prediction has been made).

There are several disclosures related to methods for training machine learning models. Document US 2020/0 912 904 A1 discloses techniques for classifications based on annotation of information. In one example, a system trains a convolutional neural network based on training data and a plurality of images. The plurality of images is also associated with a plurality of masks, a plurality of image level labels, and/or a bounding box. The system also generates a first loss function based on the plurality of masks, a second loss function based on the plurality of image level labels, and a third loss function based on the bounding box. As a result, the system predicts a classification label for an input image based on the convolutional neural network (CNN).

Additionally, the publication titled, “Explainable Artificial Intelligence: a Systematic Review” by Guilia Vilone & Luca Longo highlights the importance of explainable AI (XAI) in the context of article 22 of the EU (European Union) general data protection regulation (GDPR) which sets out the rights and obligations of the use of automated decision making. Noticeably, the Guilia Longo publication introduces the right of explanation by giving individuals the right to obtain an explanation of the interference/s automatically put used by a model, confront and challenge and associated recommendation, particularly when it might negatively affect an individual legally, financially, mentally or physically. However, currently available systems do only have limited functions in respect to giving reasons for the predictions.

Therefore, there is a significant need to overcome these limitations in current approaches to explaining the more or less black box function of artificial intelligence systems and to provide a method and a related system so that recommendations/predictions are understandable or interpretable by humans by also producing the underlying reasons for the predictions.

### SUMMARY

Embodiments of the present invention disclose a computer-implemented method, a machine-learning computer system, and a computer program product for training an explaining machine learning model.

The computer-implemented method for training an explaining machine learning model may include one or more processors configured for providing an untrained machine-learning model and proving training data for the machine-learning model comprising training input data. Thereby, each of the training input data element may relate to a prediction label representing an expected prediction value, as well as to a concept label, wherein the concept label may relate to a reason why the expected prediction label may be expected given the training input data element. Furthermore, the computer-implemented method may include simultaneously updating, during a supervised training of the machine-learning model, prediction parameter values, as well as, concept parameter values, thereby building the explaining machine-learning model.

In an embodiment, a machine-learning computer system for a training an explaining machine-learning model may be provided. The system may include a processor and a memory, the memory communicatively coupled to the processor, wherein the memory may store program code portions that, when executed, may enable the processor, to provide an untrained machine-learning model, and to provide training data for the machine-learning model comprising training input data. Thereby, each of the training input data element may relate to a prediction label representing an expected prediction value as well as to a concept label, wherein the concept label may relate to a reason why the expected prediction label is expected given the training input data element. Additionally, the program code portions may enable the processor to update simultaneously, during a supervised training of the machine-learning model, prediction parameter values as well as concept parameter values, thereby building the explaining machine learning model.

The computer-implemented method for training an explaining machine learning model may offer multiple advantages, technical effects, contributions and/or improvements.

For example, embodiments described herein overcomes the current limitations of existing explainable AI techniques. In existing explainable AI systems, the approaches to also deliver explanations may be described as an add-on and an afterthought in respect to the underlying prediction engine. The explaining components are not directly woven into the architecture of the respective machine learning models.

In contrast, the training data for the embodiments described herein comprises a triplet of data, namely: besides a training data element—i.e., an image—and the typically available expected prediction output value—i.e., the annotation—also at least one concept label is used for an existing training data element and a respective expected prediction output value. Thus, for a supervised learning approach, the set of training data is enriched by one or more related reasons—or, in other words, concepts—for specific expected results—i.e., the prediction values itself.

One way to achieve the specified expected results is by using a concept layer—in case a neural network is used as the underlying machine-learning model—in which certain nodes of the neural network are selected to represent the concepts, and thus, the reasons for a specific prediction or classification of input data. However, this is not limited to artificial neural networks, but it may be applied to a large variety of different artificial intelligence systems and architectures.

In another embodiment, a smaller set of training data may be used to achieve the same results if compared to traditional AI systems. In other words, the prediction of the machine-learning model may be traced back to human interpretable concepts thanks to the interpretable concept layer and the fact that this may be related to the output of the model in a functional way that is interpretable by a domain expert. Thereby, the concepts represented by the concept layer as an additional output of the prediction may represent elementary objects which, possibly in combination, may provide an explanation to a human for a classification. As a result, the model may be able to provide an explanation of its prediction by relating the file classification with the relevant elementary concepts.

Furthermore, during training, in addition to the input-output pairs typically defining training data for supervised learning and defining the classification task, the additionally used concept values for the training can be interpreted as privileged information. As such, according to the known Learning Using Privileged Information (LUPI) framework, explanations may increase the sample efficiency and accuracy of the model, i.e., they may allow to train the machine learning model with competitive levels of accuracy (or better) while reducing the number of training samples significantly. This may allow a better and more efficient usage of available computing resources, storage capacities and/or network bandwidth during training as well as during an operation/prediction phase of the ML system. This may also reduce the manual work involved in creating annotated training data which may reduce the burden and time it takes for staff to create the labels and/or annotations for the training data.

Furthermore, dependent concepts may also be addressed by embodiments described herein. For example, if there is one concept B depending on another concept A, this dependency may also be represented by the machine-learning model described herein. For instance, in neural networks, this dependency may be encoded by placing concepts A into a layer prior to the layer that represents concept B. Thus, the machine-learning model does not have to learn explicitly this dependency, which may explain why a smaller training set may be used for learning. Thus, by correctly defining such dependencies, this new approach may allow to represent logical consequences between the concepts as well, in short, concept A=>concept B=>outcome.

In the following, additional embodiments of the inventive concept—applicable for the method as well as for the system—will be described.

According to example embodiments of the computer-implemented method, the machine-learning model may be selected from one of an artificial neural network, a deep neural network, a convolutional neural network, a recurrent neural network, a transformer-based neural network, a vector-support machine, a rules-based neural network, a graph neural network, and a decision tree. Hence, many different machine-learning models may be supported by the embodiments described here. Furthermore, an implementation using a neural network may prove to be more popular than other versions of machine-learning models due to inherent characteristics of neural networks.

In an embodiment, the machine-learning model may be a neural network, and output values of the machine-learning model may comprise a plurality of class values and one or more concept values. Hence, even if only one class may be output by the related machine-learning system, the system may also output a plurality of concept values. Now, if the concept values may be interpreted as the reason for output a class as a leading class—e.g., because it has the highest related prediction probability value—then the explainable ML model or system may deliver, in parallel, a series of reasons for a specific prediction.

According to an example embodiment of the computer-implemented method, the machine-learning model may be a neural network and a total loss function L for at least a part of the neural network—in particular, for the portion before the concept layer—may be expressed as

L=f(L_{P},L_{C}), wherein

L_{P} may correspond to a loss function component relating to the expected prediction value and L_{C} may correspond to a loss function component relating to the concept label, and “f” may represent a general function of the variables L_{P} and L_{C}. In an embodiment, the function may be in addition of the two loss function components L_{P} and L_{C}. The reason why such a combined loss function may only work for the part before the concept layer may due to the fact that the concept layer—in the case of a neural network—is not the same as the output layer for a classification output of the neural network. Instead, the concept layer may be positioned as part of or among the hidden layers of the near a network.

According to another example embodiment, during the training a value of the total loss function L—in particular, the portion before the concept layer in a feed-forward model—as well as the loss function component L_{P} relating to the expected prediction value—in particular, for the portion after the concept layer in the feed-forward model—may be minimized. Therefore, the general concept of neural network training may be modified but not generally replaced in order to achieve the advantages concept of an explaining AI system.

According to another example embodiment, the machine-learning model may be a neural network, and during an operational phase—i.e., prediction or inference phase—of the neural network after training (i.e., in the inference phase), for each set of input data values—in particular, each input tensor—the machine-learning model may predict class values (i.e., classifications) with a respective class confidence values, as well as related concept values with respective concept confidence values. Hence, the general concept (i.e., cost predictions and related probability of confidence values) of neural network systems may be kept functioning while the additional idea of concept value outputs may be added on top, i.e., interwoven into the layers and nodes of the neural network. Hence, the underlying reasons, i.e., the concept values, may become an integral part of every prediction process, are not and will not be realized as an artificially added additional function of the general neural network. Similar concepts may be formulated for non-CNN machine-learning models.

According to another example embodiment, all—or a subset of—related predicted concept values are output, in particular, together with the prediction. Thus, a neural network used as a classification system for predicting a class having a confidence value may, at the same time, output together with a plurality of related concept values, i.e., reasons for the predicted class. In other words, several reasons for a specific recommendation of the ML system may influence the basis for a specific classification.

According to another example embodiment, for a given predicted class, only those related predicted concept values, having a value above or below a predefined concept threshold value, or having a value between a predefined concept threshold range may be output together with a predicted class. Such an approach may help to reduce “reason noise” from the machine-learning model. Hence, not too many reasons/concepts may be output with a classification value output such that no over-interpretation of over-explanation may occur. Concept confidence values may be used to be compared against the predefined concept threshold value.

Additionally, also alternative settings may be possible: It may be assumed that three concepts A, B, C may be possible for a predicted value, wherein the concept values have concept confidence values of 0.1, 0.5 and 0.9. Under the above proposed threshold idea, concept A may not be output because its concept confidence value may be below the threshold value. However, concept C may be output because its concept confidence value may be above the threshold value. Concept B may be inconclusive. Thus, it would also be valuable information—i.e., an explanation—to the user why concept A is absent and concept C is presented as output. The proposed inventive concept may also enable such configurations.

According to an embodiment, each of the training input data element may relate to a plurality of concept labels. This approach may mirror the idea of producing more than one concept for a given predicted class. In other words, for a predicted recommendation several reasons (i.e., concepts) may play a role.

According to an embodiment, the machine-learning model may be a neural network comprising a plurality of layers—including an input layer, a plurality of hidden layers and an output layer—comprising layer nodes and weighted links between adjacent layers nodes, and at least one of the plurality of layers of the neural network may be a concept layer. Thereby, at least a portion of the layer nodes of the concept layer may be concept nodes representing output nodes for the concept values. Hence, the concept nodes may be for the concept outputs what the output layer of the last layer of neural network may be for the classification output.

Thereby, the concept layer(s) may be represented by any of the layers—or portions thereof—apart from the input layer of the neural network. Only in exceptional cases, the concept layer may be part of the output layer of the neural network, i.e., the last layer in a feed-forward model. If that would be the case, this type of neural network may be described as a degenerated form.

According to an embodiment, nodes representing a single concept may be distributed across a plurality of neural network nodes. For example, it may also be possible that nodes representing one concept output may be positioned in a layer N of the neural network, while another concept output may be represented by a node in layer N+1. The designation specific nodes to represent specific concepts may be reflected by the output of the loss function and its feeding to selected nodes and selected—in particular, hidden—layers of the neuronal network.

According to an embodiment, the computer-implemented method may also comprise receiving—in particular from a human supervisor—a correction for a predicted class value and/or one or more predicted concept values—in particular, during the operational or prediction phase—aggregating a plurality of such corrections and using the corrections as new training data for the machine-learning model. Thereby, the training data for further training sessions may be generated as a side effect during the operational phase of a machine-learning model. A further option may be that the functioning of the neural network may also be updated during the operations phase.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

It should be noted that embodiments of the invention are described with reference to different subject-matters. In particular, some embodiments are described with reference to computer-implemented method type claims, whereas other embodiments are described with reference to apparatus type claims. However, a person skilled in the art will gather from the above and the following description that, unless otherwise notified, in addition to any combination of features belonging to one type of subject—matter, also any combination between features relating to different subject—matters, in particular, between features of the computer-implemented method type claims, and features of the apparatus type claims, is considered as to be disclosed within this document.

### BRIEF DESCRIPTION OF THE DRAWINGS

FIG. 1 shows a block diagram of the computer-implemented method for a training of an explaining machine-learning (ML) model, in accordance with an embodiment of the present invention;

FIG. 2 shows a block diagram for a modified training of the ML model, in accordance with an embodiment of the present invention;

FIG. 3 shows a block diagram of the trained ML model during the operational phase, in accordance with an embodiment of the present invention;

FIG. 4 shows a block diagram of a practical example in the field of infrastructure surveillance, in accordance with an embodiment of the present invention;

FIG. 5 shows a block diagram of a neural network illustrating the idea of the concept layer, in accordance with an embodiment of the present invention;

FIG. 6 shows a block diagram of the inventive machine-learning system for training of an explaining machine-learning model, in accordance with an embodiment of the present invention; and

FIG. 7 shows a computing system comprising the system according to FIG. 6, in accordance with an embodiment of the present invention.

### DETAILED DESCRIPTION

In the context of this description, the following conventions, terms and/or expressions may be used:

The term ‘explaining machine-learning model’ may denote a machine-learning model for a machine-learning system being adapted for performing predictions based on input data. Typically, the machine-learning model may be trained with annotated training data, i.e., pairs of input data elements and related expected output data, i.e., the prediction outputs. In addition to this, for each training data element and its respected expected output data (annotation or ground truth), one or more concept values are also part of the training data for the ML model. Thus, the machine-learning model may be enabled, during the prediction phase, not only to predict output values based on input data but also related concepts which may be interpreted as reasons for a prediction of a certain prediction value. Thus, the ML model may also output reasons for a specific recommendation.

The term ‘untrained machine-learning model’ may denote a “naked” machine-learning model. During the training—using annotated training data during a supervised training approach—prediction parameter values and concept parameter values are adjusted. Thereby—in particular, in case of a neural network as ML model—the prediction parameter values, and the concept parameter values, may relate to parameters for activation functions of specific nodes of the neural network as well as weight values for connections between nodes of different layers of the neural network. In case of other machine-learning models than neural networks, corresponding parameter settings may occur during the training phase for the respective ML model, e.g., an adjustment of a decision tree.

The term ‘training data’ may denote here at least a triplet comprising a training data element (e.g., an image), a label value representing the expected prediction value, as well as an expected concept value to be output by nodes of the concept layer(s). Hence, a plurality of different concept values may exist for one annotation of an input data element, i.e., one expected prediction value.

The term ‘prediction label’—or more precisely, prediction label value—may denote an annotation value for the training phase of the ML model.

The term ‘expected prediction value’ may denote the value of a node (or a plurality thereof) of the output layer of a neural network. A specific expected prediction value may be used as annotation for each data element for the training of the neural network.

The term ‘concept label’ or more precisely, concept label value—may denote an annotation value for the training phase of the ML model. Hence, the concept labels may mirror the idea of prediction labels as expected output values of the ML model during the prediction phase.

The term ‘supervised training’ may denote the known idea of training a ML model using training data elements together with annotation data representing the expected output value of the underlying ML model for a minimizing of the output value of a loss function for back propagation.

The term ‘prediction parameter values’ may denote variables—sometimes also denoted as hyper-parameters or parts thereof for a machine-learning model—describing values of internal parameters of the ML model. In case of a neural network, this may comprise types and values of parameters of activation functions of specific nodes of the neural network and/or weight values for connections/links from nodes of one layer to nodes of another layer of the neural network.

The term ‘concept parameter values’ may denote corresponding values to the prediction parameter values as just described. Here too—in the case that a neural network is the underlying architecture of the ML model—the concept parameter values may also relate to parameters of activation functions of certain nodes as well as to the weight values for links between nodes of different layers of the ML model.

The term ‘neural network’ may denote the known concept of a network of artificial nodes mimicking the function of a mammal brain using natural neurons and synapses to facilitate a “thinking process”. A neural network may comprise an input layer, a plurality of hidden layers and an output layer of artificial neural network nodes.

The term ‘output value’ may denote a value at a specific node of the output layer of a neural network. Typically, the node associated to a specific class having the highest confidence value in parallel to its output value may represent the predicted class. A comparable concept may be used for the output value of a concept value relating to a specific output value of a prediction (i.e., a class) of the output layer of the neural network.

The term ‘class value’ may denote an output value of a node of an output layer of the neural network relating to a specific prediction class.

The term ‘concept value’ may denote an output value of a node of a concept layer of the neural network relating to a specific concept.

The term ‘total loss function’ may denote a combination of the loss function relating to the expected prediction value and the loss function component of the expected concept value during a supervised training of a neural network. In a simple form, the total loss function may be the sum of the partial loss function. However, also other functions for the combination may be used.

The term ‘operational phase’ may denote the prediction phase of a machine-learning model and the underlying artificial intelligence system.

In the following, a detailed description of the figures will be given. All instructions in the figures are schematic. Firstly, a block diagram of an embodiment of the inventive computer-implemented method for a training of an explaining machine-learning model is given. Afterwards, further embodiments, as well as embodiments of the machine-learning system for training of an explaining machine-learning model will be described.

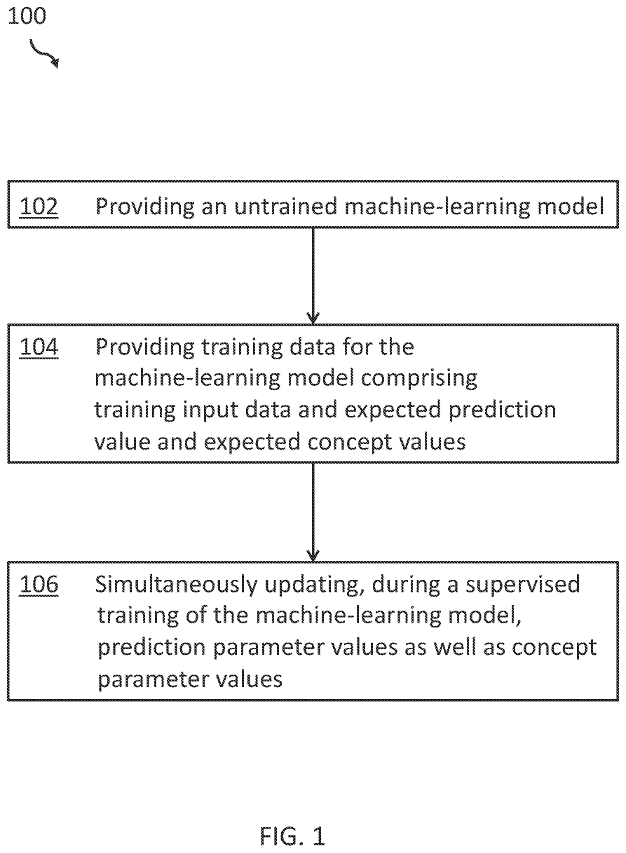

FIG. 1 shows a block diagram of the computer-implemented method 100 for a training of an explaining machine-learning model, in accordance with an embodiment of the present invention. Computer-implemented method 100 comprises providing, 102, an untrained machine-learning model. For example, the untrained machine-learning model may include an artificial neural network (ANN), a convolutional neural network (CNN), a deep neural network (DNN, comprising a large plurality of hidden layers), all comprising nodes and links between selected nodes. Additionally, decision tree systems and rule-based systems may also be used as generative adversarial networks (GAN), recover rent neural networks (RNN), region-based neural networks (R-CNN), and other types of machine-learning models may also be used.

In an embodiment, computer-implemented method 100 comprises proving, 104, training data for the machine-learning model comprising training input data, wherein each of the training input data element relates to a prediction label—representing the so-called ground truth data—representing an expected prediction value, e.g., a class expected—as well as at least one concept label. Thereby, the concept label relates to a reason why the expected prediction label is expected given the training input data element.

In an embodiment, computer-implemented method 100 comprises updating, 106, simultaneously, during a supervised training of the machine-learning model, prediction parameter values as well as concept parameter values, thereby building the explaining machine-learning model. The parameter values may thereby relate to weight values for links between different nodes of different layers and a neural network, or structures of another type of ML model, a rearranging decision tree in case of a decision tree as used ML model, and so on.

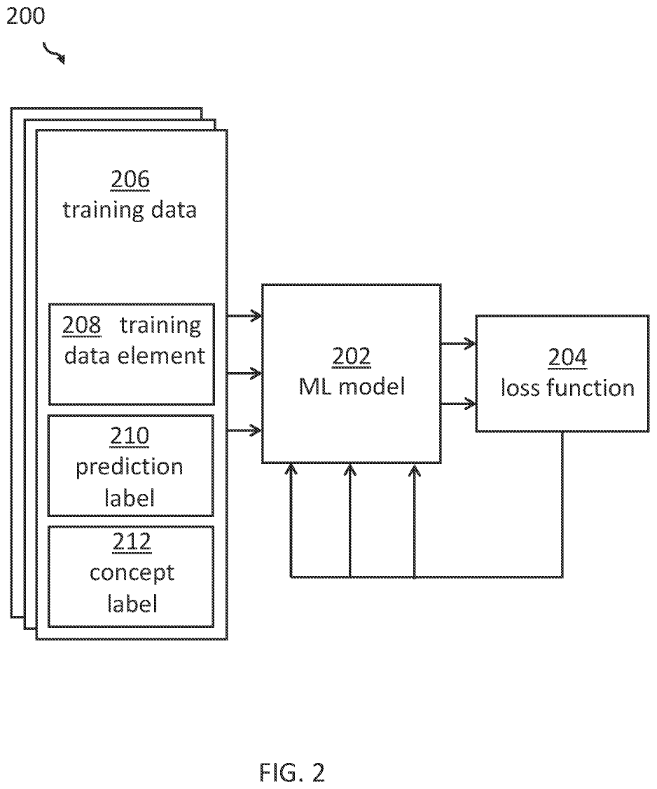

FIG. 2 shows a block diagram 200 for a modified training of the ML model, in accordance with an embodiment of the present invention.

In an embodiment, machine-learning model 202 is fed with training data 206 to minimize the value of a loss function 204. During the training, the value of the loss function is back propagated to functions of all layers of ML model 202. By comparing prediction label or annotations 210 for input training data elements 208, the value of the loss function can be minimized. Thereby, typically, weight factor values or other parameters of ML model 202 are adjusted. Such ML models 202 may then—during the interference, prediction of operational phase—be operated in a feed-forward approach, meaning that the values delivered to the input layer of ML model 202 are step-by-step propagated through the architecture or layers of ML model 202. In case of a neural network as ML model 202, output values of nodes of a hidden layer are input to nodes of the next layer of the neural network using individual weighing factors for the links.

In an embodiment, a specific feature of the inventive concept proposed here can be seen in the additional training data, namely the concept label 212 data. For each pair of training data element 208 and prediction label 210, at least one additional concept label 212 exists and may be understood as a reason why a specific prediction label 210 would be expected for a given training data element.

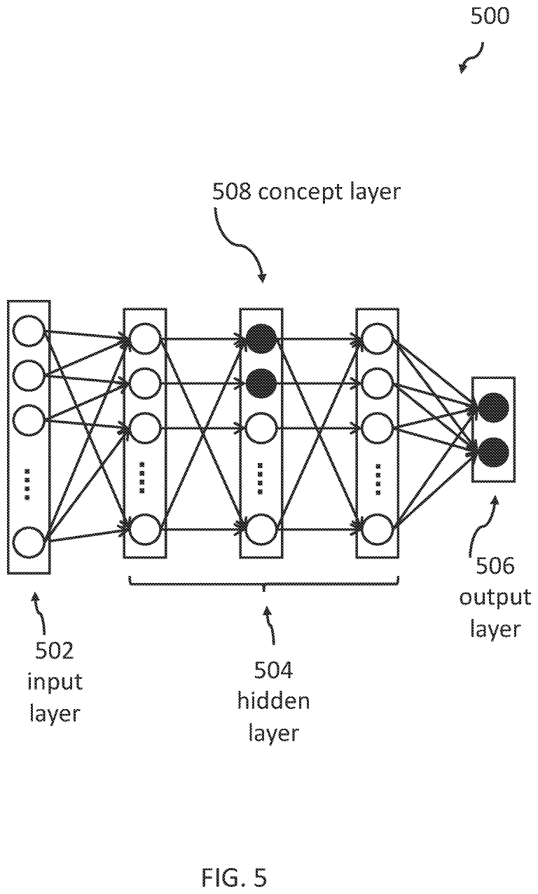

In other words, while typical supervised learning training happens by providing an input-output pair, the here proposed “explaining at learning framework” uses an input-explanation-output triple (i.e., an input-concept-output). As usual, inputs are provided to the ML model to compute the activations of the output neurons whose discrepancy with a desired training output determine the value of an output loss function. In addition, the corresponding activations of the interpretable concept neurons (compare FIG. 5 below) can be compared to the provided desired explanation and the resulting difference determines the value of the explanation loss function. Training then proceeds by iterative minimization of the combined loss function obtained from the output loss and the expectation loss. The expectation loss can then be interpreted as a regularization term constraining the capacity of the ML model. Crucially, such regularization loss is constructed so as to reflect relevant domain knowledge useful for determining the final output, thanks to the interpretable nature of the concept neuron's layer.

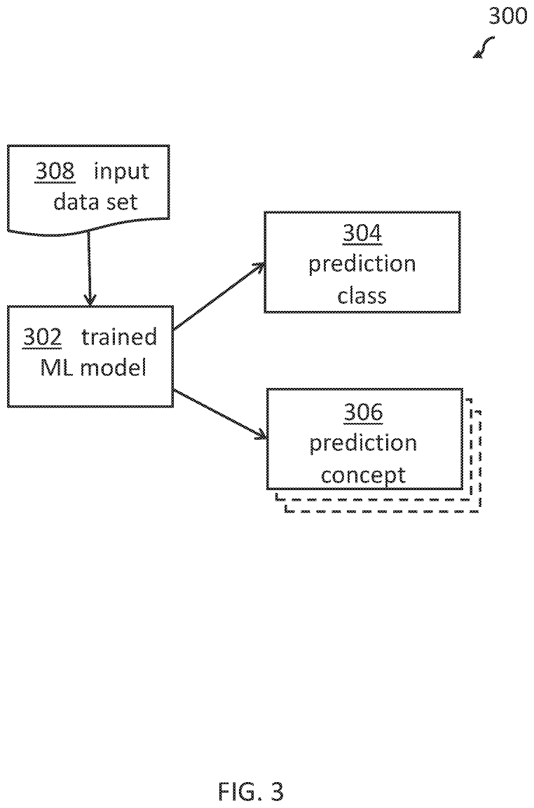

FIG. 3 shows a block diagram 300 of trained ML model 302 during the operational phase, in accordance with an embodiment of the present invention.

In an embodiment, instead of only outputting prediction classes value as a result of input data to trained ML model 302—potentially besides confidence values for the predicted class value—trained ML model 302 also outputs at least one prediction concept value 306 for a given prediction class value 304. Hence, according to the concept of explainable AI, for each predicted class, trained ML model 302 also provides a reason—i.e., at least one related concept—why the predicted class is the result of an input data set 308.

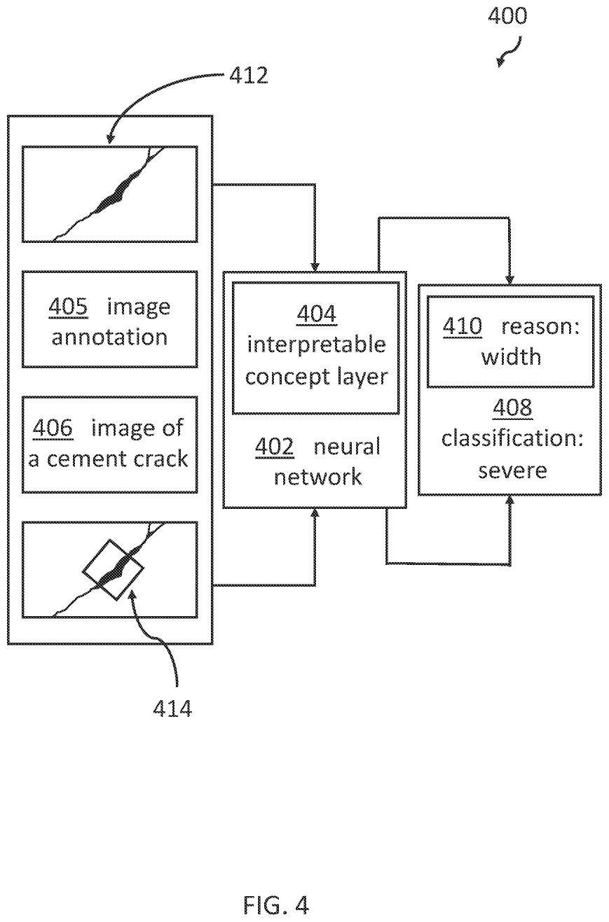

FIG. 4 shows a block diagram of a practical example in the field of infrastructure surveillance, in accordance with an embodiment of the present invention.

In an embodiment, images may be taken by a drone (e.g., UAV unmanned aerial vehicle) equipped with a camera and from the perspective of infrastructure components (not shown) such as building surfaces, bridges, roads, and pillars for wind energy generators. The image data captured by the camera may be fed to the trained neural network 402 (compare with trained ML model 302, FIG. 3). If trained neural network 402 would not be equipped with an interpretable concept layer 404, the prediction output of received images would classify any input image showing a problematic area if the image shows a crack 414 in the surface or similar problematic areas. Thus, a traditional neural network would indicate why a specific imperfection in the input image would be a reason for classifying the image comprising a severe damage.

However, instead of only annotating the training data with an image annotation 405, the training data for each training data element (e.g., an image) also comprises one or more human interpretable concepts which may here relate to the concept of a specific width of the image 412 of cement crack 406 of the infrastructure component. Concept of the width of the crack 406 represents the reason why the image of the infrastructure component is classified as showing a severe damage. Neural network 402 with the interpretable concept layer 404 outputs a classification of the input image to be classified with classification 408 “severe”, as well as the concept representing the reason 410, namely the width of the cement crack.

Another aspect illustrating that it is not strictly required that a confidence threshold value is above a certain threshold value, like in: if x % probability (i.e., confidence threshold value) exists that there is rust, then maintenance is required. However, even of the concept values are below the concept threshold value, they can be sued to form an explanation because they show an absence of a concept. Hence, this specific spot is unlikely to need maintenance because no rust and cracks can be identified.

FIG. 5 shows a block diagram of a neural network illustrating the idea of the concept layer, in accordance with an embodiment of the present invention.

In an embodiment, the typical elements of a neural network are shown as input layer 502, hidden layer 504 and output layer 506, wherein hidden layer 504 may include a plurality of hidden layers. Each of the layers comprise a plurality of nodes—symbolized by circles. There may be dozens, hundreds, or even thousands of hidden layers in the neural network (deep neural network). In case of an image as input, the number of nodes at the input layer may correspond to the number of pixels of the image. The nodes of the output layer 506 are shown as solid black dots whereas other nodes, not providing any output outside the neural network, are shown as hollow circles.

However, one of the layers also comprises black solid circles, representing output nodes of the concept layer 508. The output values of the black marked nodes of concept layer 508 are those associated with one or more concepts related to a given prediction output value from output layer 506.

It shall also be noted that the concept nodes may be distributed across a layer, i.e., they do not need to lie side by side to each other. Additionally, they may also be distributed across more than one of the hidden layers. In a degenerated form of the neural network, they may also be a part of the output layer.

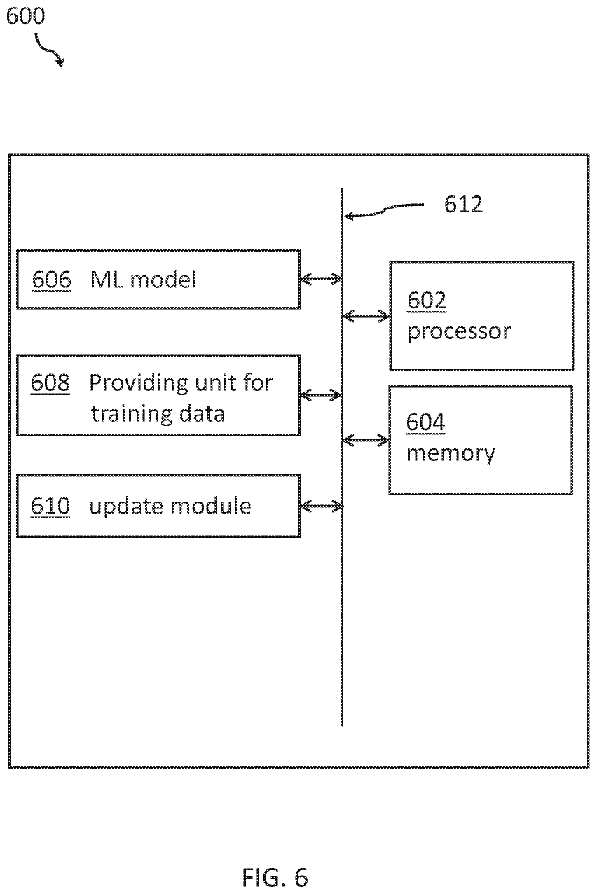

FIG. 6 shows a block diagram of the inventive machine-learning system 600 for training of an explaining machine-learning model, in accordance with an embodiment of the present invention.

In an embodiment, system 600 comprises processor 602 and memory 604, wherein, memory 604 is communicatively coupled to processor 602, and wherein memory 604 stores program code portions that, when executed, enable processor 602, to use (i.e., provide, in particular, ML model 606) an untrained machine-learning model, and to use (i.e., provide, in particular, using providing unit 608) training data for the machine-learning model comprising training input data. Thereby, each of the training input data element relates to a prediction label representing an expected prediction value as well as to a concept label, and the concept label relates to a reason why the expected prediction label is expected given the training input data element.

In an embodiment, system 600 is also adapted by executing program code to update simultaneously (in particular using update module 610), during a supervised training of the machine-learning model, prediction parameter values as well as concept parameter values, thereby building the explaining machine-learning model.

In an embodiment, all functional units, modules and functional blocks may be communicatively coupled to each other for signal or message exchange in a selected 1:1 manner. Alternatively, the functional units, modules and functional blocks—namely, processor 602, memory 604, ML model 606, providing unit 608 for the training data and update module 610—can be linked to system internal bus system 612 for a selective signal or message exchange.

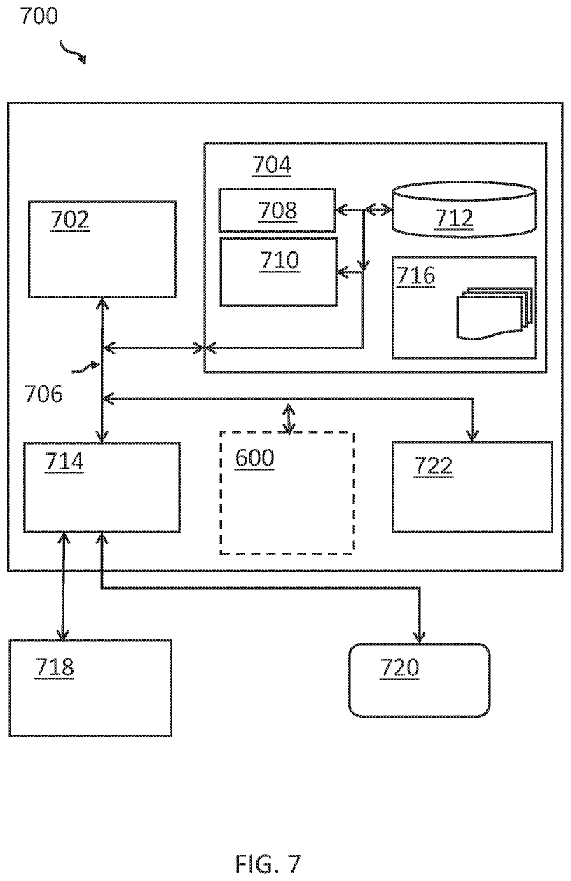

Embodiments of the invention may be implemented together with virtually any type of computer, regardless of the platform being suitable for storing and/or executing program code. FIG. 7 shows, as an example, computing system 700 suitable for executing program code related to the proposed method.

FIG. 7 shows a computing system comprising the system 700 according to FIG. 6, in accordance with an embodiment of the present invention.

In an embodiment, computing system 700 is only one example of a suitable computer system and is not intended to suggest any limitation as to the scope of use or functionality of embodiments of the invention described herein. Regardless, computer system 700 is capable of being implemented and/or performing any of the functionality set forth hereinabove. In computer system 700, there are components, which are operational with numerous other general-purpose or special purpose computing system environments or configurations. Examples of well-known computing systems, environments, and/or configurations that may be suitable for use with computer system/server 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 700 may be described in the general context of computer system-executable instructions, such as program modules, being executed by computer system 700. Generally, program modules may include routines, programs, objects, components, logic, data structures, and so on that perform particular tasks or implement particular abstract data types. Computer system/server 700 may be practiced in distributed cloud computing environments where tasks are performed by remote processing devices that are linked through a communications network. In a distributed cloud computing environment, program modules may be located in both, local and remote computer system storage media, including memory storage devices.

As shown in FIG. 7, computer system/server 700 is shown in the form of a general-purpose computing device. The components of computer system/server 700 may include, but are not limited to, one or more processors or processing units 702, system memory 704, and bus 706 that couple various system components including system memory 704 to processing units 702. Bus 706 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 700 typically includes a variety of computer system readable media. Such media may be any available media that is accessible by computer system/server 700, and it includes both, volatile and non-volatile media, removable and non-removable media.

In an embodiment, system memory 704 may include computer system readable media in the form of volatile memory, such as random access memory (RAM) 708 and/or cache memory 710. Computer system/server 700 may further include other removable/non-removable, volatile/non-volatile computer system storage media. By way of example only, a storage system 712 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 706 by one or more data media interfaces. As will be further depicted and described below, memory 704 may include at least one program product having a set (e.g., at least one) of program modules that are configured to carry out the functions of embodiments of the invention.

In an embodiment, the program/utility, having a set (at least one) of program modules 716, may be stored in memory 704 by way of example, and not limiting, as well as an operating system, one or more application programs, other program modules, and program data. Each of the operating systems, one or more application programs, other program modules, and program data or some combination thereof, may include an implementation of a networking environment. Program modules 716 generally carry out the functions and/or methodologies of embodiments of the invention, as described herein.

In an embodiment, computer system/server 700 may also communicate with one or more external devices 718 such as a keyboard, a pointing device, a display 720, etc.; one or more devices that enable a user to interact with computer system/server 700; and/or any devices (e.g., network card, modem, etc.) that enable computer system/server 700 to communicate with one or more other computing devices. Such communication can occur via Input/Output (I/O) interfaces 714. Still yet, computer system/server 700 may communicate with one or more networks such as a local area network (LAN), a general wide area network (WAN), and/or a public network (e.g., the Internet) via network adapter 722. As depicted, network adapter 722 may communicate with the other components of the computer system/server 700 via bus 706. It should be understood that, although not shown, other hardware and/or software components (e.g., microcode, device drivers, redundant processing units, external disk drive arrays, RAID systems, tape drives, and data archival storage systems) could be used in conjunction with computer system/server 700.

Additionally, machine-learning system 600 for a training of an explaining machine-learning model may be attached to bus 706 system.

The descriptions of the various embodiments of the present invention have been presented for purposes of illustration but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid-state memory, magnetic tape, a removable computer diskette, random access memory (RAM), a read-only memory (ROM), a rigid magnetic disk and an optical disk. Current examples of optical disks include compact disk-read only memory (CD-ROM), compact disk-read/write (CD R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the C programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of computer-implemented methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms a, an, and the, are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for training an explaining machine-learning model, the computer-implemented method comprising:
providing, by one or more processors, an untrained machine-learning model;
providing, by the one or more processors, training data for the machine-learning model comprising training input data elements, wherein each of the training input data elements relates to a prediction label representing an expected prediction value as well as to a concept label, wherein the concept label relates to a reason why the expected prediction label is expected given the training input data elements; and
simultaneously updating, by the one or more processors, during a supervised training of the machine-learning model, prediction parameter values as well as concept parameter values, thereby building the explaining machine-learning model.

2. The computer-implemented method of claim 1, wherein the machine-learning model is one selected out of the group consisting of an artificial neural network, a deep neural network, a convolutional neural network, a recurrent neural network, a transformer-based neural network, a vector-support machine, a rules-based neural network, a decision tree, and a graph neural network.

3. The computer-implemented method of claim 1, wherein the machine-learning model is a neural network, and wherein output values of the machine-learning model comprise a plurality of class values and a plurality of concept values.

4. The computer-implemented method of claim 1, wherein the machine-learning model is a neural network and wherein a total loss function L for at least a part of the neural network is L=f (L_{P}, L_{C}), wherein L_{P} corresponds to a prediction loss function component relating to the expected prediction value, L_{C} corresponds to a concept loss function component relating to the concept label, and f corresponds to a function of L_{P} and L_{C}.

5. The computer-implemented method of claim 4, wherein during the training a value of the total loss function L as well as the prediction loss function component relating to the expected prediction value is minimized.

6. The computer-implemented method of claim 1, wherein the machine-learning model is a neural network, and during an operational phase of the neural network after training, for each set of input data values, the machine-learning model predicts class values with a respective class confidence values as well as related concept values with respective concept confidence values.

7. The computer-implemented method of claim 6, wherein for a given predicted class, all related predicted concept values are output.

8. The computer-implemented method of claim 6, wherein for a given predicted class all related predicted concept values having a value above or below a predefined concept threshold value or having a value between a predefined concept threshold range are output.

9. The computer-implemented method of claim 1, wherein each of the training input data elements relates to a plurality of concept labels.

10. The computer-implemented method of claim 1, wherein the machine-learning model is a neural network comprising a plurality of layers comprising layer nodes and weighted links between adjacent layer nodes, and wherein at least one of the plurality of layers is a concept layer, wherein at least a portion of the layer nodes of the concept layer are concept nodes representing output nodes for the concept values.

11. The computer-implemented method of claim 10, wherein the concept nodes representing a single concept are distributed across a plurality of neural network nodes.

12. The computer-implemented method of claim 1, further comprising:
receiving, by the one or more processors, a correction for a predicted class value or a predicted concept value;
aggregating, by the one or more processors, a plurality of the corrections; and
using, by the one or more processors, the plurality of corrections as new training data for the machine-learning model.

13. A machine-learning computer system for training an explaining machine-learning model, the system comprising:
one or more computer processors;
one or more computer readable storage media;
program instructions collectively stored on the one or more computer readable storage media for execution by at least one of the one or more computer processors, the stored program instructions comprising:
program instructions to provide an untrained machine-learning model;
program instructions to provide training data for the machine-learning model comprising training input data elements, wherein each of the training input data elements relates to a prediction label representing an expected prediction value as well as to a concept label, wherein the concept label relates to a reason why the expected prediction label is expected given the training input data elements; and
program instructions to simultaneously update, during a supervised training of the machine-learning model, prediction parameter values as well as concept parameter values, thereby building the explaining machine-learning model.

14. The machine-learning computer system of claim 13, wherein the machine-learning model is one selected out of the group consisting of an artificial neural network, a deep neural network, a convolutional neural network, a recurrent neural network, a transformer-based neural network, a vector-support machine, a rules-based neural network, a decision tree, and a graph neural network.

15. The machine-learning computer system of claim 13, wherein the machine-learning model is a neural network, and wherein output values of the machine-learning model comprise a plurality of class values and a plurality of concept values.

16. The machine-learning computer system of claim 13, wherein the machine-learning model is a neural network and wherein a total loss function L for at least a part of the neural network is L=f (L_{P}, L_{C}), wherein L_{P} corresponds to a prediction loss function component relating to the expected prediction value, L_{C} corresponds to a concept loss function component relating to the concept label, and f corresponds to a function of L_{P} and L_{C}.

17. The machine-learning computer system of claim 16, wherein during the training a value of the total loss function L as well as the prediction loss function component relating to the expected prediction value is minimized.

18. The machine-learning computer system of claim 13, wherein the machine-learning model is a neural network, and during an operational phase of the neural network after training, for each set of input data values, the machine-learning model predicts class values with a respective class confidence values as well as related concept values with respective concept confidence values.

19. The machine-learning computer system of claim 18, wherein for a given predicted class, all related predicted concept values are output.

20. The machine-learning computer system of claim 18, wherein for a given predicted class all related predicted concept values having a value above or below a predefined concept threshold value or having a value between a predefined concept threshold range are output.

21. The machine-learning computer system of claim 13, wherein each of said training input data element relates to a plurality of concept labels.

22. The machine-learning computer system of claim 13, wherein the machine-learning model is a neural network comprising a plurality of layers comprising layer nodes and weighted links between adjacent layer nodes, and wherein at least one of the plurality of layers is a concept layer, wherein at least a portion of the layer nodes of the concept layer are concept nodes representing output nodes for the concept values.

23. The machine-learning computer system of claim 22, wherein nodes representing a single concept are distributed across a plurality of neural network nodes.

24. The machine-learning computer system of claim 13, further comprising:
program instructions to receive a correction for a predicted class value or a predicted concept value;
program instructions to aggregate a plurality of the corrections; and
program instructions to use the plurality of corrections as new training data for the machine-learning model.

25. A computer program product for training an explaining machine-learning model, the computer program product comprising:
one or more computer readable storage media and program instructions collectively stored on the one or more computer readable storage media, the stored program instructions comprising:
program instructions to provide an untrained machine-learning model;
program instructions to provide training data for the machine-learning model comprising training input data elements, wherein each of the training input data elements relates to a prediction label representing an expected prediction value as well as to a concept label, wherein the concept label relates to a reason why the expected prediction label is expected given the training input data elements; and
program instructions to simultaneously update, during a supervised training of the machine-learning model, prediction parameter values as well as concept parameter values, thereby building the explaining machine-learning model.
